(19) United States
(12) Patent Application Publication
(10) Pub. No.: US 2024/0119546 A1
(43) Pub. Date: Apr. 11, 2024

(54) MULTI-AGENCY PLATFORM FOR REAL ESTATE AGENTS TO HIRE AND NETWORK WITH OTHER REAL ESTATE AGENTS WITHIN SILOS OF AGENCIES

(71) Applicant: Yvonne Oriaku, Washington DC, DC (US)

(72) Inventor: Yvonne Oriaku, Washington DC, DC (US)

(21) Appl. No.: 17/962,519

(22) Filed: Oct. 9, 2022

(51) Int. Cl. G06Q 50/16; G06Q 10/10

(52) U.S. Cl. CPC G06Q 50/16; G06Q 10/101

(57) ABSTRACT

A multi-agency platform that provides a system for real estate agents to hire other real estate agents within silos/Chinese walls of agencies where payments for showings are made on a number-of-doors-opened basis, while payments for attendance to home inspections, open houses, walkthroughs, and other licensed real estate agent activities are made on a number-of-hours-spent basis. The multi-agency platform allows agents to be concurrently added to multiple silos on a state by state basis for the ability to network with other agents within the same silos on the same platform.

### BACKGROUND

### Technical Field

This disclosure relates to a software-as-a-service platform for allowing real estate agent users to communicate with each other. In particular, and without limitation, the disclosure relates to a multi-agent platform that allows real estate agents to use the same collaboration tools on one platform and relates to a structured compensation scheme thereof.

Software-as-a-service collaboration platforms for real estate are known in the art.

U.S. Pat. No. 11,069,004 discloses a mobile computing device for facilitating electronic communication among users in a network including professional acquaintances.

U.S. Pat. No. 11,238,467 discloses a user active lead management system and uses thereof.

US 2018/0060981 discloses a network-leveraged real estate transaction assistance system and method.

US 2018/0068400 discloses a property listing system and method.

US 2020/0219212 discloses a method and system for managing and allocating real estate related services.

US 2021/0042861 discloses a method and apparatus for automated collaboration in a real property merchandising system.

WO 2014/073981 discloses a system for real estate transactions.

Real-estate agents currently handle their collaboration needs over email, Facebook groups and other ineffective means. In addition, payments to associated real-estate agents working together do not account for task-based compensation in performing typical real-estate related tasks. Therefore, a need exists for a system that allows real estate agents to find other affiliated agents who are within the same real estate agency/brokerage and can collaborate and be rewarded for networking with other real estate agents.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The disclosure relates to a system that software-as-a-service that allows real estate agents to find other affiliated agents who are within the same real estate agency/brokerage communications and use the same collaboration applications.

In one aspect, a multi-agency platform provides an application to allow agents to communicate and collaborate with others in an agency for collaboration.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is an example communications network to support the disclosure.

FIG. 2 is an example block diagram of intra-collaboration services provided by the multi-agency platform.

FIG. 3 is an example block diagram of inter-collaboration services provided by the multi-agency platform.

### DETAILED DESCRIPTION

The elements in the figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

A multi-agency platform is disclosed that provides a system for real estate agents to hire other real estate agents within silos/Chinese walls of agencies where payments for showings are made on a number-of-doors-opened basis, while payments for attendance to home inspections, open houses, walkthroughs, and other licensed real estate agent activities are made on a number-of-hours-spent basis. The multi-agency platform allows agents to be concurrently added to multiple silos on a state by state basis for the ability to network with other agents within the same silos on the same platform.

The disclosed multi-agency platform is a software-as-a-service that allows real estate agents to find other affiliated agents who are within the same real estate agency/brokerage. The system was built for use by licensed real estate agents. All agents within the system must work under the supervision of a brokerage/agency. Agents of the same agency/brokerage are able to find and hire each other to conduct showings, home inspections, walkthroughs and other licensed real estate tasks. The software consists of a mobile and web application.

When agents sign up, they select their agency which allows them to be able to be pooled into the same group/agency by the system, which is called a “Chinese Wall” of separation. Agents in an agency cannot make contact, view, or find and hire agents who belong to a different agency/brokerage because of this Chinese Wall except in limited instances.

The disclosed platform is a multi-agency/multi-brokerage platform that allows for intra-collaboration within the agency/brokerage by the agents who make up the membership of the agency. In one aspect of the disclosure, the platform provides the ability for multiple agencies/brokerages and their agents to have access to the same collaboration tools on one the same platform.

The disclosed platform allows intra-collaboration tools such as applications that allow:
the ability to search, find, hire, and pay other agents within the same agency/brokerage who are available to assist with licensed real estate tasks;
agents to sync their calendars, which allows the system to pair them up to available tasks/jobs within their agency/brokerage;
multiple agencies/brokerages to be hosted and housed within this same software platform yet limited from each other as it relates to agent-collaboration;
agents to provide coming soon listings and the expected go-live date for those listings that can be viewed solely by other agents within the same agency, and the clients of the agency;
multiple agencies/brokerages can manage all of their coming soon listings on the same platform, that also allows them to be able to market these listings to their customers and clients independently of other agencies/brokerages;
agents can schedule open houses for their listings, which other agents within the same agency/brokerage can find and apply to host;
multiple agencies/brokerages to now market, not only open house times, but also information about the agent who will be hosting the open house, how long they have worked in real estate, among other information, within the same platform, to the consuming public; also, payments for attendance to home inspections, open houses, walkthroughs, and other licensed real estate agent activities are made on a number-of-hours-spent basis.
the public to now go to one singular platform where they can view open houses being hosted by multiple different agencies/brokerages, as well as in-depth details about the agent who will be hosting the open house should they decide to visit.
agents to communicate in a messaging service to other agents who are within the same agency/brokerage;
agents to post licensed real estate activities that they need help with to a job board that can only be viewed by the other agents within their same agency/brokerage; and
agents to view posted licensed real estate tasks from agents within their same agency/brokerage.

The disclosed system, in one aspect of the disclosure, is a multi-agency/multi-brokerage platform that allows for inter-collaboration among the agents that make up the different agencies/brokerages within a geographic marketplace. Using the applications disclosed herein, real estate agents to share the housing needs of the buyers and sellers that they represent in a geographic area. The disclosed platform allows buyers and sellers in a geographic area to be able to search and view the needs of other buyers and sellers in the same geographic area and represented by licensed real estate agents. The consuming public of buyers and sellers can only view and access this platform by virtue of their being represented by a licensed real estate agent who the system empowers to provide with unique access.

The inter-collaboration tools offered by the disclosure include:
the ability of agents in one agency/brokerage to share the housing desires (needs) of their buyers and sellers with agents of different agencies/brokerages in a geographic marketplace;
the ability of agents in one agency/brokerage to view the housing desires (needs) of buyers and sellers represented by agents of different agencies/brokerages in a geographic marketplace;
the ability of agents to communicate in a messaging service to other licensed real estate agents within a geographic marketplace;
multiple agencies/brokerages to manage all of their buyers' and sellers' needs on the same platform;
multiple agents and agencies/brokerages to market their buyers' & sellers' needs to other agents and to different agencies/brokerages and their clients;
multiple agencies/brokerages buyers' & sellers' needs to be hosted and housed within this same platform; and
the ability for buyers and sellers to search and be matched up to other buyers and sellers who meet their needs.

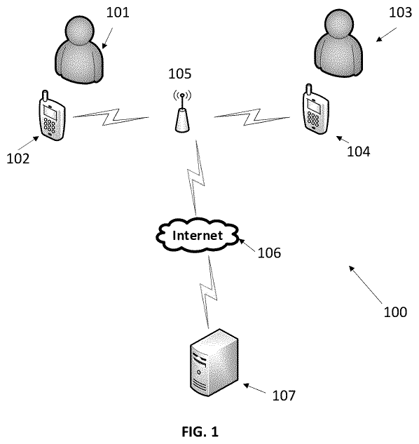

FIG. 1 illustrates an example communications network 100 employed by users 101, 103 that supports the multi-agency real estate platform according to an aspect of the disclosure. In an aspect of the disclosure, the users (101, 103) may be a real-estate agent or agency, a buyer seeking information about properties, or a seller looking to list his or her property for sale.

The communications network 100 may include a first user equipment (UE) 102 and a second UE 104. There may be multiple UEs connected to the communications network 100 and the UEs may be smart phones, laptops, tablet devices, smart watches, desktop computers, or other equipment that can connect in a wired or wireless manner. The communications network 100 may include a wired or wireless access point AP 105. The AP 105 may be a terrestrial wireless network such as a cellular communications network, WiFi network or other wireless connectivity systems. The AP 105 may be a satellite that supports ground-based communications. Examples of a wired communications network includes Ethernet, fiber, cable or other wired communications connectivity systems.

In an aspect of the disclosure, the AP 105 may connect to the Internet 106, as understood by one of skill in the art. The Internet 106 may include various routers and hubs (not shown).

In an aspect of the disclosure, the Internet 106 may connect UEs 102, 104 to a server 107. The server 107 may contain processors, input units, memory, and output display units (not shown). The server 107 may support the functions of the disclosure, such as hosting the multi-agency platform and/or components of the multi-agency platform. The server 107 may be multiple servers and the method of the disclosure may be implemented across multiple servers, the UEs 102, 104 or other processing devices as needed. The server 107 may also include a cloud-based collection of one or more servers distributed in different locations and/or or making use of cloud-based applications to implement the disclosed disclosure.

In an aspect of the disclosure, the server 107 may be located in local proximity to the UEs 102, 104 such that the UEs 102, 104 do not access the Internet 106 to make use of the disclosed disclosure.

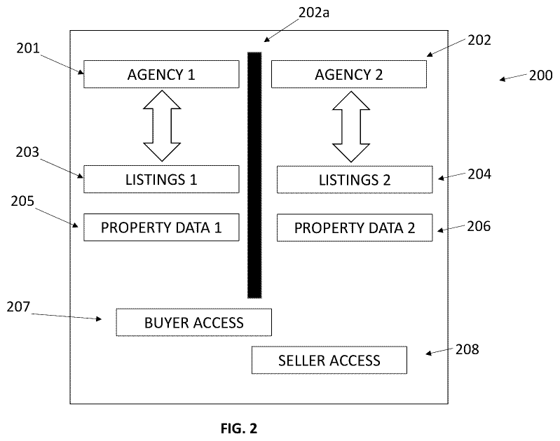

FIG. 2 is a block diagram illustrating the intra-collaboration tools of the multi-agency platform 200. The multi-agency platform 200 may be located on a server 107, distributed across multiple servers, cloud-based or stored as components of a UE 102, 104. The multi-agency platform 200 may include a processing module for one agency or agent 201 and a processing module for a second or additional agencies/agents 202. The number of agencies/agents and their corresponding modules on the multi-agency platform 200 as illustrated in FIG. 2 need not be two and can be scaled up to multiple agencies/agents as needed by the users. The processor module 201, 202 need not be hosted in the same server, and may be hosted in distributed servers, cloud based or implemented on a UE 102, 104.

The processor module 201, 202 may be configured to allow agencies/agents to make use of software applications resident on the multi-agency platform 200, such as messaging services, storage and memory services, graphical user interface (GUI) services, calendaring and scheduling services, collaboration services, such as virtual white boarding and videoconferencing services, authentication services, virtual partition services (“Chinese Wall”) 202a to prevent conflicts in representation for real estate agents of one agency and real estate agents of a second (or more) agency and other applications and services that may be needed to implement the multi-agency platform 200.

The virtual partition services module 202a is designed to exclude agents/agencies from viewing another agent/agency's information, data, seller and buyer information and other services and data that could create an ethical conflict. When agents sign up, they select their agency which allows them to be able to be pooled into the same group/agency by the system, a Chinese Wall of separation. Agents in an agency cannot make contact, view, or find and hire agents who belong to a different agency/brokerage because of this Chinese Wall of separation. The virtual partition services 202a may be implemented in various ways and techniques. One method is a total firewall between the two or more agents/agencies, where no contact is permitted at. Another method of the virtual partition services 202a could enable passwords, authentication, one-time passcodes and other methods known to one of skill in the art. The latter examples of the virtual partition services 202a may be used in limited circumstances in aspects of the disclosure discussed herein.

The collaboration services hosted by the multi-agency platform 200 are configured to allow the first agent to communicate with other agents of the first agency for assistance with real estate related tasks that may include communicating a need for assistance for property showings, open house events, walkthroughs, home inspections and other licensed real estate tasks; and to pay the other agents for showings on a number-of-doors-opened basis, and to pay to the other agents for attendance with home inspections, open houses, walkthroughs and other licensed real estate tasks on a number-of-hours-spent basis.

Other aspects of the disclosure allow agent/agency information to be stored or called from a data storage. The agent/agency information may include personal profiles, sales history, experience, languages spoken and other information of interest to a consumer when viewing real estate listings. This information may be configured for display on a GUI or screen of a Windows, Apple or Android device.

The multi-agency platform 200 may also include property listings services 203, 204 of a first agent/agency and second agent/agency. The property listing services 203, 204 includes information about real estate properties for sale in a particular geographic region. Other data may include town, street or subdivision of the real estate property, single family or multiple family housing, townhouse or condominium for sale. The property listing services 203, 204 may include a list number for quick identification of the real estate property, The property listing services 203, 204 may include information about the real estate agency, real estate agent or broker associated with the real estate listing, as well as other pertinent information related to the real estate property listing.

In one aspect, the multi-agency platform 200 includes a first property data service 205 and a second data service 206 associated with a first agent/agency 201 and a second agent/agency 202. The first property data service 205 may include additional information that may be pertinent the real estate properties in the property listings services 203. The second property data service 206 may include additional information that may be pertinent to the real estate properties in the property listings services 205. Examples of property data include demographic, social and geographic information, history of the property and surrounding region, schools located nearby, fire and rescue service locations near the property, property tax, homeowner association, nearby parks, recreation, shopping, regional transit services and other types of information of interest to a buyer or seller. The first and second property data services 205, 207 may include video walk-throughs of the property, diagrams and maps of the property, floor plan layout and other spatial-related multimedia available related to the property. The first and second property data 205, 207 may also enable augmented reality displays for buyers to consider placement of furniture and home accessories. The first and second property data services 205, 207 may provide links to other similar properties nearby for comparison as well the capability to provide comparison data with other nearby properties. Mortgage rates and types (fixed or adjustable) for the particular property may also be available. Other property data services may be provided, as more information available about the property enhances the decision process for a customer considering the property listing.

The multi-agency platform 200 may include buyer access services 207 and seller access services 208. Buyer access services 207 allow a buyer, associated with a particular real estate agent or agency, to communicate with their agent about property listings of interest and view listings of their agent/agency.

Seller access services 208 allow a seller, associated with a particular real estate agent or agency, to communicate with their agent about buyers of interest, status of the property sale, interest from buyers, possible adjustments of the price of the seller's property and other criteria a seller may specify.

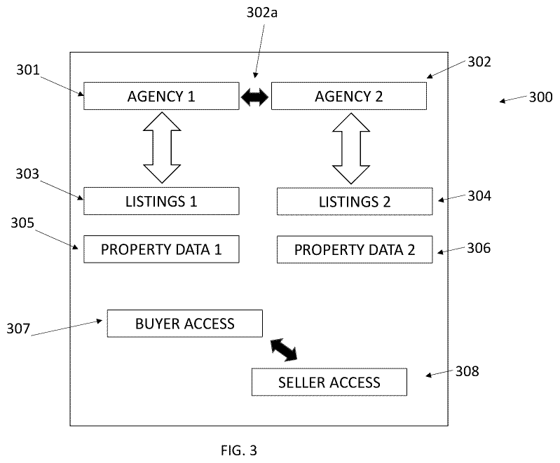

FIG. 3 illustrates another aspect of the multi-agency platform 300. The multi-agency platform 300 provides inter-collaboration tools for an agent/agency/broker and inter-collaboration tools for agent/agency/broker. As with the multi-agency platform 200, an agent or broker may contact the multi-agency platform 300. When agents sign up with the multi-agency platform 300, they select their agency, which allows them to be able to be pooled into the same group/agency by the multi-agency platform 300.

The agent obtains access to intra-collaboration tools to work with other agents in the agency pool. A processor module for an agent/agency 301, 302 functions in much the same manner as the processor module for an agent/agency 201, 202. The inter-collaboration tools of the multi-agency platform 300 enable the ability of agents in one agency/brokerage to share the housing desires (needs) of their buyers and sellers with agents of different agencies/brokerages in a geographic marketplace. The agents in one agency/brokerage can view the housing desires (needs) of buyers and sellers represented by agents of different agencies/brokerages in a geographic marketplace on the same multi-agency platform 300. In an aspect of the disclosure, the multi-agency platform 300 may allow agents to communicate in a messaging service 302a to other licensed real estate agents within a geographic marketplace, so that, on the same platform, multiple agencies/brokerages can manage all of their buyers' and sellers' needs on the same platform and market their buyers' & sellers' needs to other agents and to different agencies/brokerages and their clients.

The collaboration services hosted by the multi-agency platform 300 are configured to allow the first agent to communicate with other agents of the first agency for assistance with real estate related tasks that may include communicating a need for assistance for property showings, open house events, walkthroughs, home inspections and other licensed real estate tasks; and to pay the other agents for showings on a number-of-doors-opened basis, and to pay to the other agents for attendance with home inspections, open houses, walkthroughs and other licensed real estate tasks on a number-of-hours-spent basis.

In one aspect of the multi-agent platform 300, sellers may be permitted to search for buyers their own agent/agency as well as buyers from other agents/agencies. The seller access services 208 may allow the seller to contact buyers with matching criteria to suggest a possible transaction between the seller and buyer.

The sequences and actions described in FIG. 2 and FIG. 3 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the communications network 100. Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A method for a multi-agency platform to provide intra-collaboration services for real estate agents, the method comprising:
providing access to the multi-agency platform to a first agent associated with a first agency hosted on the multi-agency platform;
allowing the first agent to communicate with other agents of the first agency for assistance with real estate related tasks;
providing intra-collaboration services for use only between the first agent and other agents of the agency, where second agents of a second agency are prevented from accessing first agency data by a virtual partition service; and
allowing access to the multi-agency platform by a first client of a first agency, where access to the first agency data is prohibited to a second client of the second agency.

2. The method of claim 1, where allowing the first agent to communicate with other agents of the first agency comprises providing messaging services between the first agent and the second agent, while prohibiting a first agent or second agent prohibits access to the messaging service by the second agent of the second agency.

3. The method of claim 1, where allowing the first agent to communicate with other agents of the first agency for assistance with real estate related tasks comprises communicating a need for assistance for property showings, open house events, walkthroughs, home inspections; and
paying the other agents for showings on a number-of-doors-opened basis, and payments to the other agents for attendance to home inspections, open houses, walkthroughs are made on a number-of-hours-spent basis.

4. The method of claim 1, where providing intra-collaboration services comprises providing real estate property listings to the first client and/or other agents of the first agency, where the real estate property listings comprise information about active listings, coming soon listings and an expected go-live date that can be viewed only by other agents of the first agency and the first clients.

5. The method of claim 4, where the real estate property listings comprise information about an agent who will be hosting the open house, experience of the agent, demographic information about the real estate property, geographic information about the real estate property listings, community information about the real estate property listing and comparable real estate property listings within the multi-agency platform to the first client.

6. The method of claim 1, where providing intra-collaboration services for use only between the first agent and other agents of the agency comprises providing real estate task services that are accessible only to the first agent of the first agency.

7. A method for a multi-agency platform to provide inter-collaboration services for real estate agents, the method comprising:
providing access to the multi-agency platform to a first agent associated with a first agency hosted on the multi-agency platform;
providing access to the multi-agency platform to a second agent associated with a second agency hosted on the multi-agency platform;
providing inter-collaboration services for use between the first agent and the second agent, where the second agent is prevented from accessing first agency data by a virtual partition service;
allowing, through an exception in the virtual partition service, the first agent to communicate with the second agent to share housing needs of a first real estate client with the second agent in a geographic marketplace; and
allowing access to the multi-agency platform by the first client of the first agency and the second client of the second agency, where the first agent of the first agency and the second agent of the second agency are allowed access to the intra-collaboration services to search for a matching listing based on housing needs.

8. The method of claim 7, where allowing the first agent to communicate with the second comprises providing messaging services between the first agent and the second agent.

9. The method of claim 7, where the virtual partition services comprise a firewall between the first agency and the second agency on the same multi-agency platform, where the firewall allows exceptions for communication between the first agent and second agent.

10. The method of claim 7, where providing inter-collaboration services comprises providing real estate property listings to the second agent, where the real estate property listings comprise information about active listings, coming soon listings and an expected go-live date.

11. The method of claim 10, where the real estate property listings comprise information about an agent who will be hosting an open house, experience of the agent, demographic information about the real estate property, geographic information about the real estate property listings, community information about the real estate property listing and comparable real estate property listings within the multi-agency platform.

12. A multi-agency platform to provide collaboration services for real estate agents comprising:
a first agency hosted on the multi-agency platform, where the first agency comprises at least one first real estate agent;
a second agency hosted on the multi-agency platform, where the second agency comprises at least one second real estate agent;
one or more collaboration services, where the one or more collaboration services comprise an intra-collaboration services and an inter-collaboration services;
a first storage of first real estate property listings accessible only to the first agent and a second real estate property listings accessible only to the second agent; and
a first client associated with the first agent and a second client associated with the second agent.

13. The multi-agency platform of claim 12, where the one or more collaboration services is an intra-collaboration services.

14. The multi-agency platform of claim 12, where the one or more collaboration services is an inter-collaboration services.

15. The multi-agency platform of claim 13, where the first agent and the second agent are prevented from communication with each other using a virtual partition services.

16. The multi-agency platform of claim 13, where the inter-collaboration services allow the first agent to communicate with the second agent to share housing needs of a first real estate client with the second agent in a geographic marketplace.

17. The multi-agency platform of claim 13, where the first client of the first agency and the second client of the second agency are allowed access to the intra-collaboration services to search for a matching listing based on housing needs.

18. The multi-agency platform of claim 12, where the first real estate property listings comprise information about an agent who will be hosting an open house, experience of the agent, demographic information about the real estate property, geographic information about the real estate property listings, community information about the real estate property listing and comparable real estate property listings within the multi-agency platform.

19. The multi-agency platform of claim 14, where inter-collaboration services comprises providing real estate property listings to a second agent associated with the first agent, where the real estate property listings comprise information about active listings, coming soon listings and an expected go-live date.

20. The multi-agency platform of claim 12, where the one or more collaboration services is configured to allow the first agent to communicate with other agents of the first agency for assistance with real estate related tasks comprises communicating a need for assistance for property showings, open house events, walkthroughs, home inspections; and configured to pay the other agents for showings on a number-of-doors-opened basis, and pay the other agents for attendance to home inspections, open houses, walkthroughs are made on a number-of-hours-spent basis.
